(19) United States
(12) Patent Application Publication
(10) Pub. No.: US 2024/0070571 A1
(43) Pub. Date: Feb. 29, 2024

(54) Methods and Systems for Conducting Pairing Processes to Identify Transport Sources

(71) Applicant: Liftago, a.s., PRAGUE (CZ)

(72) Inventors: David Mayer, Prague (CZ); Ondrej Krátký, Prague (CZ); Tibor Mlynarik, Prague (CZ)

(73) Assignee: Liftago, a.s., PRAGUE (CZ)

(21) Appl. No.: 17/822,190

(22) Filed: Aug. 25, 2022

(51) Int. Cl. G06Q 10/06; G08G 1/00

(52) U.S. Cl. CPC G06Q 10/0631; G08G 1/202; G06Q 50/30

(57) ABSTRACT

A computer-implemented method for conducting pairing processes to identify transport sources. Rules for the pairing processes are generated based on a transport request received from a client interface. The rules determine parameters such as when the process is initiated, or how many iterations it has. Transport sources are then pre-selected in a certain area and sources not fulfilling necessary criteria, e.g., unable to transport the subject of the transport described in the transport request or busy with another transport, are excluded. The remaining sources receive pairing values which can be accepted by the sources. From the accepting sources, one can be confirmed from the client interface.

### BACKGROUND OF THE INVENTION

This invention relates in general to a computer implemented method for finding suitable transport sources, e.g., personal transport drivers, delivery drivers, or anyone else with means to provide transportation services, according to requirements received through a client interface.

Methods for pairing transport sources to clients or customers known in the art generally receive a transport request from a customer, i.e., data about pickup and delivery locations, time of pickup, etc., and arrange for the transport. The customer does not have any insight into how a particular driver was paired to the transport or how much the driver gets paid. Other methods known in the state of the art let the customer to choose a particular driver, e.g., based on price or customer rating.

Such methods look for drivers only among drivers belonging to a particular fleet or a particular transport company, so the customer needs to use a different method (e.g., a different website or app) when they need to transport himself or other people then when they need to transport certain goods or objects. Known methods do not offer a shared capacity of more available sources than those currently contracted by the provider of this method.

These known methods provide limited flexibility and effectivity. During peak hours, the whole fleet of drivers available through a certain method might be unavailable, while during off-peak hours, significant part of given fleet might have nothing to transport. For customers, this means that finding suitable transport source might be difficult, especially during peak hours. For transport sources, this means that their vehicles and employees are not utilized effectively.

It would therefore be advantageous to provide a method for pairing suitable transport sources with customers or their transports, which method would increase options for customer, enable the customer to find transport for fair price for both the customer and the driver and/or quickly available transport etc., would provide for a more effective utilization of existing transportation fleets, i.e., both the vehicles and/or their drivers, and increase computational efficiency of automatic pairing process.

### SUMMARY OF THE INVENTION

This invention relates to a computer-implemented method for conducting pairing processes to identify transport sources, i.e., finding a transport source or multiple sources, who can offer required transportation services, preferably at the lowest cost and/or with low carbon footprint and/or as close to a desired time of pickup as possible etc., and then transmitting data about the source to a client interface or arranging for the requested transport. The method includes rules generation followed by the pairing itself, wherein the pairing can occur in a single iteration or in multiple iterations. The generation occurs once during every pairing process and is a phase during which it can be decided, at least partially based on the requirements from the client interface, how and when the pairing will proceed, whether the source winning the pairing, i.e., the one who will eventually realize the transport, will be chosen by the client or automatically, whether the winner will be chosen based on a certain paring value, e.g., monetary value, time of arrival, impact on the environment or other criteria, etc.

This method enables faster and more efficient (with respect to amounts of computations needed and data transferred, which also impacts energy consumption and thus price and ecological impact) pairing of transport sources to transports required by customers. When price is used as a pairing value, a balanced price, fair to both the customer and the sources, can be found by the present method.

The method comprises the following steps:
Receiving a transport request containing at least data about a pickup location, destination location, and time of pickup, data about the subject of the transport, and data about potential special requirements including a type of payment, exclusions of some transport sources, and a request for an intermediate stop. It might also include a request for presence of a taximeter or similar hardware or software. The transport request can be a form filled in by a customer with all the customer's needs. Preferably, it is filled in and then transmitted to the method (e.g., a computer system running the method) via a client interface. The exclusion of some sources might be, e.g., based on previous negative experience with some sources, but might also be based on positive experience, e.g., excluding all sources except ones belonging to a certain company preferred by the customer. The subject of the transport might specify whether a person and/or an object/animal is to be transported, how many, how big or heavy the objects are, how fragile they are, etc. The customer can choose some or none of the special requirements or include other requirements, e.g., for a premium ride (high-end vehicle)/efficiency ride (e.g., older vehicle, lower price), for an electric/hybrid vehicle, for a refrigerated van, conversation requirements (e.g., language), etc.
Generating rules for the pairing based on information contained in the transport request, wherein the rules include at least a maximum number of iterations of the pairing process, a time limit for source response, and a point in time for initiating the pairing process. The rules can further be based on data configured in the method/the computer system implementing it (e.g., data stored in a database), or data acquired from third-party services, such as historical data on number of potential sources available through the method at certain areas at certain times, map or traffic data, weather data, previous numbers of iterations needed to find a source, etc. The rules preferably further define whether the pairing is automatic (The system chooses a source if more of them are willing to provide the requested transport, the system might also determine a fixed price. As a result, some transports, e.g., deliveries for some company, might be handled by source chosen by the system in order to ensure required quality or speed of delivery.) or interactive (source data are transmitted to the customer who decides). This might be based on the transport request, i.e., the customer chooses what type of pairing suits them, or it might be automatically chosen, e.g., all personal transport pairing processes (subject of the transport comprises a person, e.g., taxi rides or limousine rides) are interactive while all delivery transports (no people are to be transported) have automatic pairing processes (which simplifies finding transport sources for businesses sending off large amounts of goods). Whether a pairing process is automatic or interactive can also depend on how the customer makes his request. For example, automatic personal transport pairing processes can be used for pre-orders (transport requests made in advance, e.g., at least several hours or days in advance) and requests made via web application. Interactive personal transport pairing processes can then be used for transports requested via client interface in form of a mobile application which enables the customer to easily interact with the method. Delivery pairing can then always be automatic or can also depend on the medium used for requesting the transport. Specifying whether a pairing process is automatic or interactive can thus depend on the subject of the pairing process, i.e., personal transport or delivery, without other data from the transport request affecting this rule. For interactive pairing processes, a time limit for client response, i.e., how long a customer has to choose a source, once they receive the source data, might also be configured in this step. For automatic pairing processes, a similar time limit for receiving acceptances by the sources, after which one of them is chosen, or limit for how many sources need to accept before one of them is chosen, might be generated in this step.

The rules also preferably include grouping the iterations into stages, where each stage contains iterations with the same rules, while in different stages, some rule is different. For example, an incentive for sources, i.e., a bonus amount of money to be made by the transport, might increase in later stages, if no source can be found in earlier stages, to increase the likelihood the pairing will be successful. The incentive might also decrease as the pairing advances to a next stage, e.g., if more sources become available. Later stages can for example have more pre-selectable drivers, e.g., by broadening the pre-selection radius or by exclusion less drivers (e.g., considering universal drivers for a personal transport pairing only in later stages). Time limit for source/client response might also increase in later stages, sources might be looked for in a larger area, some requirements from the transport request might be loosened, etc. The pairing might also switch to an automatic mode in later stages, where a source is automatically confirmed (i.e., wins the pairing process) if they accept the transport. Preferably, each source is offered the transport (a pairing value is transmitted to them as described below) at most once each stage. Changing the rules as the pairing goes on increases the likelihood that a source will be found and speeds the pairing up. Grouping the iterations into stages simplifies the pairing process, e.g., by limiting computational complexity of the pairing process, limiting the number of sources who are contacted during the pairing process, limiting the number of offers, especially the same offers, each source receives, etc.

Other rules might include for example, a group of sources to be considered in the pairing (e.g., selecting personal transport driver, delivery drivers, universal drivers, autonomous vehicles or combination thereof, based on the subject of the transport), determining how the pairing value will be determined or calculated (e.g., price based on taximeter tariff, individual source pricing, common pricing built in in the method, flat fees for a transport, incentives—flat incentive, incentive multiplier, how the incentives change between stages, etc.), how many different pairing values each source will receive (e.g., only one, based on an estimate considering length of the transport, its subject etc., or multiple different pairing values to allow each source more freedom when accepting/rejecting offered transports and eventually optimizing the pairing value, e.g., pushing the final price for the customer down), etc.

The rules might be automatically generated by predetermined criteria, such as analytical formulas for determining number of iterations based on time of pickup an expected number of potentially available sources. The generating step might also partially or entirely be carried out by a machine learning algorithm trained on data from previous pairing processes. This algorithm might thus e.g., learn how many iterations are generally needed for similar transports, what pairing value is usually accepted, what incentives might be needed, how large the radius for pre-selection needs to be etc. Using such a machine learning algorithm for generating the rules might lead to more optimal pairing processes and to finding sources cheaper and/or faster with less computational resources needed and less data transferred during the pairing process.

Some rules can dynamically change during the pairing and the manner of the changes can also be generated in this step. For example, determination of the pairing value can change during the pairing process, e.g., prices might become lower as the pairing goes on when more sources become available (e.g., once a rush-hour passes, e.g., after noon when demand for lunch deliveries decreases) or might become higher as the need for finding a source becomes more urgent. An area in which sources are pre-selected, as described below, might become larger or smaller, less suitable sources (e.g., not normally handling given type of transports) might be considered in later iterations, etc.
Initiating the pairing at the generated point in time. Initiating the pairing means initiating the first iteration—looking for sources in the area around the pickup location (sources who are there or will be there at the time of pickup etc. e.g., current transport destinations are taken into account). This point in time is determined based on expected difficulty in finding acceptable source(s), e.g., on time of the day, whether it is a working day or weekend, how busy the area around the pickup location is, how long the transport is and where it ends, how much any special requirements will complicate finding sources, etc., and also on expected maximum length of the pairing—number of iterations, length of each iteration etc. The initiate of the pairing might be immediate, e.g., within a minute from receiving the transport request, or within a second or even a fraction of a second. For personal transport pairing processes, the immediate initiate can be the most common option, e.g., when the client requests the transport without specifying a precise time of pickup. The actual time of pickup will then depend on when a source can actually make the pickup, i.e., how far the source is from the pickup location, how dense the traffic is, how long the pairing will take etc.

The method might also comprise, e.g., as a part of the step of generating rules, determining whether the initiate of the pairing should be postponed. For example, if a transport is requested several hours in advance, the pairing might initiate immediately, but it might also be determined in the method, that it would be advantageous to initiate the pairing later. For example, if the transport is requested at noon, there might be a surplus of transports at the moment because lunches are being delivered. It might thus be decided to initiate the pairing at e.g., one o'clock, when there is less demand for transport sources. As a result, a source might be found cheaper than if the pairing initiated immediately, the sources are not distracted by another pairing when they are busy with current transports, peaks in demand for transport sources are smoothed, etc. The initiate can only be postponed if the transport request, e.g., the time of pickup, does not prevent that, i.e., if there is enough time for the pairing even if postponed.

For each iteration, the pairing comprises the following steps:
Pre-selecting transport sources situated within a predetermined radius from the pickup location, based on source location data received via a source interface. The distance between a source and the pickup location is only estimated in this step, traffic is not taken into account and the distance is for example measured as a straight line or as a street-by-street distance. The source location data might describe a current position of the source and/or where they are heading—e.g., when currently serving a different transport. Sources in the area might be identified by being online in the source interface, or be setting a certain “looking-for-a-transport” status in the app. Such a status might e.g., indicate the source's current location or destination of his current transport. For example, the computer system implementing the method might have a constantly/frequently updated map with positions and optionally destinations of each online source, and this map is used when pre-selecting potentially available sources. A source might also choose to be notified or otherwise informed by his source interface or device about certain available transports which might be interesting for this source, even if the source is not online, has his app or interface implementing device turned off, has time off, etc. The source can then be for example waken up at night by a source interface notification, e.g., a phone call or notification from a mobile application or by an API request (e.g., if the source is an autonomous vehicle), if a certain transport request which is lucrative enough for them becomes available.
Receiving, from the source interface of each pre-selected source, availability and eligibility data, and excluding, based on these data, pre-selected transport sources based on exclusion criteria. These criteria might be selected from, among others, providing a conflicting or interfering transport, participating in a pairing process for a conflicting transport (or a certain number of such pairing processes/transports, e.g., participating in five concurrent pairing processes is allowed but not more than that), not having vehicle with a capacity sufficient for transporting the subject of the transport, and not meeting any potential special requirements. The method might be configured to check some of these criteria, preferably all of them, and optionally other criteria as well, e.g., a maximum carbon footprint for arrival to the pickup location. Some of the availability and eligibility data, if they are more static, might be received from the source interface in advance, e.g., when the source first uses the interface and registers into the source-finding service, and then updated by the source if the data change. This data might be saved in a database and retrieved when given source is pre-selected. Dynamic data, such as a position of the source, other transports or pairing processes of the source etc., are preferably received each iteration/stage/pairing process. Sources excluded in a previous iteration of the same stage, or even an iteration of a previous stage, might be automatically excluded or disqualified, especially if the exclusion was based on a static data (e.g., vehicle not having required capacity). Some exclusion criteria might be based on sources' preferences, rather than the customer's, e.g., sources might set a region, where they want to stay during their rides, a time window when they want to work, destination where they want to end up at the end of their workday, customer they don't want to service, etc. It is possible no pre-selected source is excluded in this step. It is also possible they all are excluded or even that no pre-selected source could be found. In such a case, a next iteration might be initiated, if there are more iterations to go.
Generating, preferably automatically, an efficiency criterion for the transport and excluding transport sources not fulfilling the efficiency criterion. The efficiency criterion comprises at least one parameter selected from a maximum distance between the source's current location or destination and the pickup location, and a maximum time of arrival to the pickup location. This criterion considers actual distance to be travelled to the pickup location and estimates time of arrival considering current traffic situation. The maximum time or distance is preferably dependent on the time of pickup, e.g., they're shorter during peak hours. There might also be a defined near-maximum time and/or distance, wherein sources with this near-maximum time/distance are not excluded but might choose to reject such rides, without negatively affecting their acceptance rates (see below).
Determining, automatically, at least one pairing value for each remaining transport source based on the transport request and transmitting the pairing value to each remaining transport source's source interface. The determination might be a computation based on an analytical formula containing parameters reflecting data from the transport request or it can be AI or machine learning based determination. The pairing value might for example be a price bid, i.e., amount of money offered to the source. It might also be, e.g., automatically calculated score reflecting multiple parameters such as price offered, distance to the pickup location, customer rating by previous transport sources etc. The pairing value might be based on each source's preferences set via the source interface, (e.g., preset price per km and per hour, a flat fee added to the price for each ride etc.) and includes any incentives or tips, as determined in previous steps. From the transport request, at least the pickup location and destination location need to be considered, preferably also the pickup time (e.g., peak traffic means more time spent means higher cost). Special requirements might also increase have impact on the pairing value, e.g., if a source sets via their interface that the pairing value should be higher if special requirements are present. Preferably, each source receives multiple pairing values, e.g., all based on the above given parameters, and differing from each other by a multiplier, by adding a certain amount etc. For example, the first pairing value might be determined solely based on the above-mentioned considerations and further pairing values might be 10% higher, 20% higher, 5% lower, 10% lower etc. The source, once they receive these pairing values, can choose which pairing value(s) are high enough for him to accept the transport, and the customer or the system than chooses one source, e.g., one accepting the lowest pairing value, from all the sources who accepted a pairing value. Sources might also be able to choose, in their source interface, to automatically accept any transport they're offered, if its pairing value is above a certain threshold, e.g., if it makes them certain amount of money per hour spent on the transport. Such sources than do not have to react to received pairing values, e.g., they will not be disturbed during driving.

The pairing value determination or calculating in embodiments where it is a monetary value might also be, at least partially, based on an amount of money a source should make per hour. E.g., some sources might set in their interface that they want to make at least 300 CZK/h. Pairing values for these sources would then reflect this parameter, since lower price containing pairing values, not amounting to this minimal hour rate, would not be accepted. This minimum rate might also be generated as a part of the method, i.e., it would not be chosen by sources themselves, but by the person/company providing the method or by a machine learning algorithm. E.g., it might be predetermined that a source should always make some minimum wage and the pairing values would reflect that.

It is possible that in this step or before it, no pre-selected sources are actually left. In that case, there is no pairing value to determine and the pairing proceeds to the next iteration, if there is a next iteration, or is terminated unsuccessfully.
Receiving (or waiting for) pairing value acceptance data from the source interface(s) during the generated time limit for source response. This data includes the statement, that the source accepts the pairing value/transport and the value, e.g., the price, the source chose in case of multiple transmitted pairing values. It might also include an estimated time of arrival to the pickup location, estimated by the source. Other data such as vehicle data or driver data (customer rating, photo, name) might also be included.

For each iteration (if the iteration isn't ended earlier, e.g., by exclusion all the pre-selected sources), the pairing further comprises one of the following steps:
If pairing value acceptance data was not received from any transport source in this iteration and the maximum number of iterations was already reached, ending the pairing process, and transmitting, to the client interface, information about the pairing being unsuccessful.
If pairing value acceptance data was not received from any transport source in this iteration and the maximum number of iterations was not yet reached, initiating next iteration.
If pairing value acceptance data was received from at least one accepting transport source, creating a set of available transport sources, and transmitting, to the client interface, data about at least one transport source from the set of available transport sources. In an automatic pairing process, the winning source is chosen by the system so the client only needs to receive data about the source who will handle the transport. This one source might be chosen e.g., according to the pairing value they accepted, to an estimated time of arrival, customer rating etc. This source might also be the only one who accepted in this iteration because in later iterations the method might often only wait for the first accepting source, i.e., choosing the winning source based on quickness of accepting (e.g., number of seconds).

In interactive pairing processes, if the set comprises at least one accepting source, their data is transmitted to the client to choose from or confirm/decline source(s). This data might comprise the pairing value, e.g., the cost of the transport, arrival time, driver info, customer rating, vehicle data etc. Any data received with the pairing value acceptance might be transmitted to the client interface, and so can be any data retrieved from a database.

The method might end at this step, since the available sources, i.e., the set of accepting sources, is created and shared with the client interface, or the client interface receives information that no source could be found. The method might however also continue with further steps, unless the pairing already ended unsuccessfully. In automatic pairing processes, when the customer is being informed about the winning source, or preferably before the customer is informed, this winning source is preferably booked, in order to prevent him from participating in or winning any conflicting pairing processes. The database forming part of the system implementing the method preferably keeps updated records about the sources and their status, especially whether they are booked or not, to prevent possible double booking of a source in case they win two pairing processes at roughly the same time. After the booking, both the customer and the source might be informed accordingly via their respective interfaces.

The booking of the winning source might also be unsuccessful, if the source is already booked, changes his status to offline or inaccessible, etc. In that case, another source accepting in the same iteration might be chosen or another iteration might initiate, if there are more iterations to go.

In interactive pairing processes, the method might wait for receiving a source confirmation from the client interface for the time specified as the time limit for client response, as will be described below in more detail.

The method of the invention enables finding a suitable source, fulfilling basically any criteria a customer might wish to check, with an optimal value of the pairing parameters. Since unsuitable sources are excluded based on multiple criteria (exclusion criteria, efficiency criteria) or are not even pre-selected, the computational efficiency of the method is improved, since no pairing values are determined for unsuitable or unavailable sources. Another advantage of the method is lowering amounts of data transmitted during the pairing process, since no data need to be transmitted to source interfaces of unsuitable sources and data about such sources don't have to be transmitted to the system running the method or to the client interface. The whole process is thus also significantly faster compared to any known methods The possibility of applying incentives, transmitting multiple pairing values to sources and choosing a source according to any criteria, either implemented as a part of the method, or received from the client interface, ensures that a source fulfilling any needs or requirements can be paired to given transport. The pairing value for the transport might initiate at low value and increase as the pairing process goes on, so, for example, the lowest value, which any source can accept, can be found. The pairing process can thus have a form of an auction where a balanced marked price is found and this price can then be the actual price for the transport.

The available and acceptable transport sources are thus identified in the present method, by firstly pre-selecting all sources within certain area, then removing unsuitable sources on the basis of exclusion and efficiency criteria and iteratively determining a paring value acceptable for both the sources and the customer. At least one suitable source is thus identified as the accepting and confirmed transport source, or the process is terminated unsuccessfully.

The method also ensures that the source winning the pairing is reasonably close to the pickup location, which further saves cost and makes the overall transport task distribution via the pairing process faster and more eco-friendly. Since the source network, i.e., the set of all the sources having the source interface who can thus be offered and provide transportation services, might comprise, and advantageously comprises, sources belonging to multiple different fleets, employed in multiple different companies, freelancers, personal transport drivers, delivery drivers, autonomous vehicles etc., the utilization of all the fleets, companies and sources is increased. The sources can not only compete with each other but also complement each other. If capacity of any given fleet or company is not sufficient to handle all the transports that need to be handled, e.g., when one company is at its peak busyness, and cannot readily handle all its deliveries, they might, as a customer using the client interface in the present method, find suitable sources to assist them. In the state of the art, each company and fleet basically needs to have enough vehicles to cover all deliveries during the peak busyness, and these vehicles are not always utilized the rest of the time. With the present method, having less vehicles and covering the peaks by outsourcing is possible. All the participating companies and fleets can thus save on vehicle and driver costs without losing any business, and the existing vehicles are better utilized.

The client interface can be, for example, a mobile application, a web page, any application programming interface in any user device such as a mobile phone, tablet, laptop etc., it can be a cloud based or server-based application etc. The source user interface can also be any of the above, it can be a part of an on-board computer in the source's vehicle, it can be a server communicating with a source or with a person redistributing transports to several drivers in their fleet etc.

The creating of the set of available transport sources in an automatic pairing process preferably comprises ranking the accepting transport sources based on at least one source attractivity criterion selected from a set comprising the pairing value accepted by each accepting source (multiple values can be determined for a source and then one or more of them might be accepted), customer rating of each accepting source, estimated time of arrival to the pickup location, and quickness in accepting the pairing value. Information about the highest-ranking accepting source, who is the winner of the pairing process, is then transmitted to the client interface, pairing process winning information is transmitted to the source interface (preferably after successful booking as described above) of the highest-ranking source, and the pairing process is ended.

These criteria are relatively easy to assess, and at the same time describe very realistically the best-source-selection process a customer would do in an interactive pairing process. The winning source is thus likely to be an entirely suitable source, e.g., the same as one that would be chosen in an interactive pairing process, i.e., the automatization speeds up the pairing significantly and does not significantly worsen the results. Any single one of these criteria, as well as a different one chosen by a skilled person, might be used. They might also be used in combination, e.g., ranking the sources by multiple criteria independently and then averaging the resulting rankings. In case of a tie, the winner might be e.g., chosen randomly.

For the interactive pairing process, the transmitting od data about at least one transport source preferably comprises transmitting of data about each transport source from the set of available transport sources to the client interface. The method then further comprises a step of receiving (or waiting for) a source confirmation data from the client interface, wherein for each iteration, the pa further comprises one of the following steps:
If source confirmation data was not received in this iteration within a predetermined time period (the client time limit for reaction made by the customer or possibly automatically by the client interface) and the maximum number of iterations was already reached, ending the pairing and transmitting, to the client interface, information about the pairing being unsuccessful.
If source confirmation data was not received in this iteration within the predetermined time period and the maximum number of iterations was not yet reached, initiating next iteration.
If source confirmation data was received, transmitting pairing winning information to the source interface of the confirmed source, and ending the pairing process. The booking or attempted booking of the winning source, as described above, preferably takes place also here. The customer is then informed about the successful booking/unsuccessful booking leads to another iteration, confirming another source from the set, or unsuccessful end of the pairing process.

In a preferable case, the method enables both the automatic and interactive pairing processes, either to be chosen by the customer, or chosen automatically at least for some transports (e.g., automatically for delivery transports, up to the customer for personal transports).

The data about each transport source, based on which the customer might make his decision, might comprise at least some of the following data:
Estimated time of arrival to the pickup location;
Pairing value of the transport accepted by the transport source;
The transport source's vehicle data;
Customer rating of the transport source.

In the step of determining the pairing value, the determination is preferably individual for each transport source and is also based on source pairing value data received from the source interface of each transport source. For example, these data might include at least one of a minimum price for a transport, maximum price for a transport, a minimum hourly rate, a maximum hourly rate, a minimum price per unit of distance, a maximum price per unit of distance, and a flat fee for a transport. The final price for the transport will then in most cases be lower with such individual determination then with the same pairing value determination for each source. The actual price for a transport might, for example be a flat fee+maximum of price based on per-hour-rate and price based on per-km-rat based on parameters set by the winning source.

Preferably, for at least some transport sources multiple pairing values are determined and transmitted, wherein the pairing value acceptance data from these at least some transport sources further comprise pairing value selection data, i.e., data describing what value was accepted.

Before the step of determining the at least one pairing value, further pre-selected transport sources can be excluded based on source-specific data including at least one of: source pricing, source customer rating, estimated time of arrival to the pickup location, source's preferred direction of travel, source's rate of accepting received pairing values in previous pairing processes, and estimated probability of accepting a pairing value in the current pairing process. Limiting the number of remaining pre-selected sources further, based on these additional criteria, limits the amount of data that need to be transmitted when the pairing value(s) are transmitted to the sources. Each source thus overall receives fewer pairing values and might be more likely to accept some of those they receive.

In case the exclusion is at least partially based on the estimated probability of accepting a pairing value in the current pairing process, the estimated probability is preferably determined based on at least some of the following data:
The source's distance to the pickup location
Time needed for arrival to the pickup location
The source's current location
Transport distance
Estimated time needed for completing the transport
Impact of potentially not accepting a pairing value in the current pairing on the source's rate of accepting received pairing values
The source's customer rating
The customer's rating by previous transport sources
Potential special requirements in the transport request
Expected availability of other transport requests at the time of pickup.

An analytical formula for estimating the probability might be formed and used. However, using a machine learning model, e.g., a neural network trained on previous data collected from the method, is preferable. The training set comprises at least some of the above-mentioned data, most preferably all of that data. Using this probability, the relevance of the transmitted pairing values is further increased, i.e., ratio of accepted pairing values to all transmitted pairing values is increased and fewer pairing values are determined and transmitted in vain. Each source then receives more relevant pairing values which limits amounts of transferred data and speeds up the pairing process.

The special requirement for exclusion of some transport sources might include at least one of excluding transport sources of at least one predetermined fleet or transport company and limiting transport sources to transport sources of at least one predetermined fleet or transport company. The customer can thus request that the transport will be provided by an employee/contractor/autonomous vehicle of a favored company/fleet or that a certain company/fleet is not included. This might be especially advantageous for customers sending of large quantities of goods and preferring all the goods to be sent by a specific fleet/company to ensure a certain standard of service, ensure that transports are handled by drivers who have undergone certain training, or autonomous vehicles having certain hardware or software etc.

The determination of the pairing value might include adding a source incentive value, generated among the rules for the pairing during the preparing of the pairing process, to the pairing value for at least some transport sources. The incentive is preferably monetary value, increasing likelihood of acceptance. The source incentive might be different in different iterations or stages and/or for different sources. For example, for a delivery transport, personal transport sources might be offered larger incentive as they generally don't provide delivery transports. In some embodiments or for some transport request, the incentive might also decrease as the pairing advances, e.g., if there is fewer transports and/or more sources during a later stage. This incentive thus increases the likelihood of finding a source in later iterations, as finding of the source becomes more urgent. Preferably, in a single stage, the incentive is the same, and only increases, if at all, when a next stage is reached, as described above.

The point in time for initiating the pairing is preferably generated based on an estimated number of pre-selectable transport sources within the predetermined radius from the pickup location at the time of pickup. The number of sources might be a deciding factor since it directly affects the difficulty or easiness of finding a suitable source. Other factors, such as length of the transport or special requirements, are preferably also considered. The estimate of number of pre-selectable sources might be determined based on historical data from previous pairing processes with similar pickup times and locations.

Transmitting the pairing value to each remaining transport source preferably further includes transmitting, to the source interface of each remaining transport source, transport data comprising at least some of the following data:
Client data and subject of the transport data
Pickup and destination locations
Time of pickup
Potential special requirements
The time limit for source response
Distance to the pickup location
Estimated time for arriving to the pickup location.

The source can then make his accept/decline decision based on more data, which improves the source satisfaction with finding work via the present method.

The method can further comprise a step of checking whether a transport can be merged with another transport or split into multiple transports. If so, another step of merging/splitting the transport might follow. This step of checking can e.g., occur after receiving the transport request. It might for example occur for delivery transports. Merging transports might be possible if their pickup locations, destinations and/or intermediate stops are close to each other or if route for one transport passes near pickup location, destination, or a stop of another transport. One source can thus be given both transports, during a single pairing process, with the method merging them together, planning the route accordingly etc., and as a result, both the transports, or even more than two of them, can be accomplished sooner, cheaper, with less ecological impact etc. The source might even be unaware that the transport they provide is actually multiple merged transports.

Similarly, splitting a transport might occur e.g., if some parts of it, e.g., some intermediate stops, the final destination etc., are close to a route of another transport. One source can then e.g., pick up the goods, hand some of the goods to a different source in an intermediate stop (e.g., planned only for the purpose of this handoff) and each source than delivers his goods to the desired places. This splitting can lead to more optimized transporting, since some goods or part of the subject(s) of transport might be delivered by another source who travels to given location(s) or close to them anyway, e.g., because of a different transport.

The decision whether transports should be split or merged might be done, e.g., by a machine learning algorithm trained on historical data, or based on same predetermined criteria, such as a difference between length of merged transports and sum of lengths of the individual transports, or difference in lengths between split transports and the whole unsplit transport.

This invention further relates to a computer system comprising means adapted for carrying out each of the steps of the method according to the invention. This system might be a cloud service, a server owned by the person or company providing the method or multiple such servers etc. The communication with the client and source interface is preferably an internet communication. The system e.g., comprises at least a processor and a memory containing software instructions for carrying out the steps of the method.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a flowchart describing the method of the invention in a general embodiment providing both an interactive pairing process, where the customer chooses via a client interface a specific source from multiple suitable and available sources found by the method, and an automatic pairing process, where the specific source is chosen by the method based on predetermined criteria.

FIG. 2 is a flowchart describing in more detail steps of determining pairing values and transmitting them to selected sources (steps 107, 108, 109 a 110 from FIG. 1).

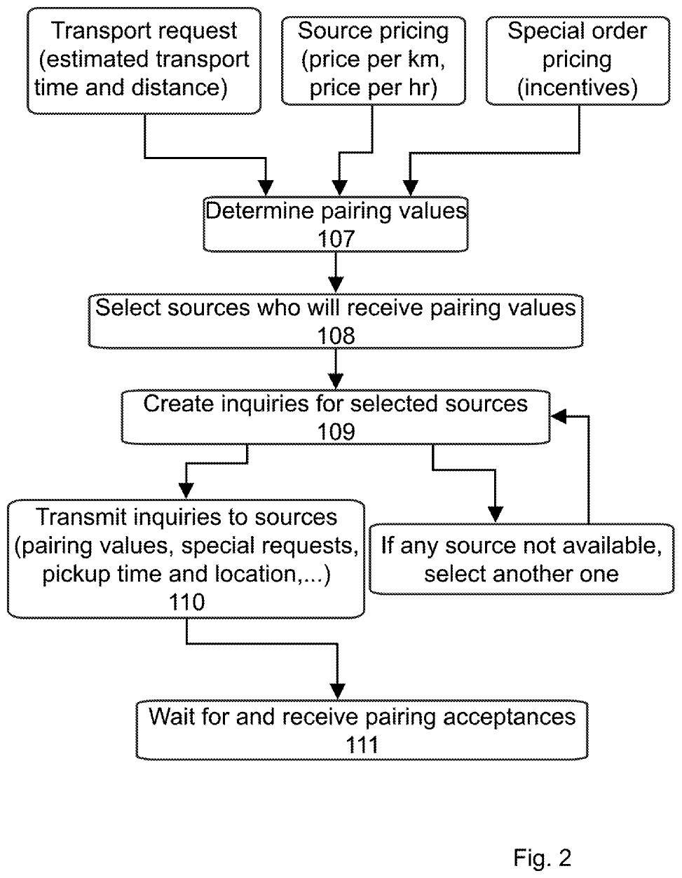

### DETAILED DESCRIPTION OF THE PREFERRED EMBODIMENT

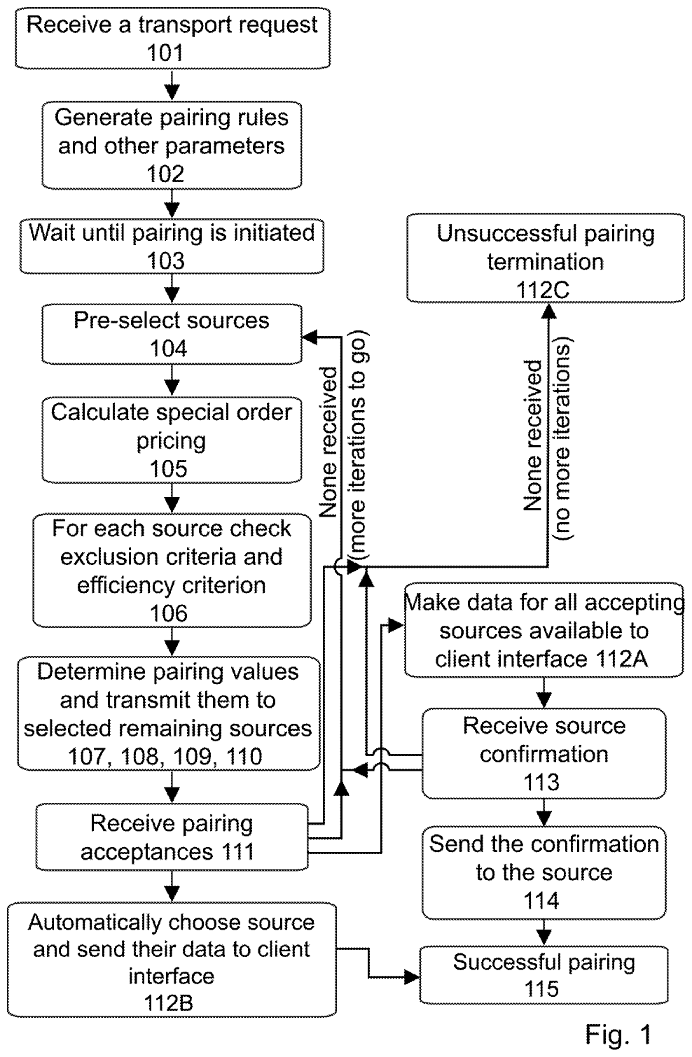

Referring now to the drawings, there is shown in FIG. 1 a flowchart illustrating the computer-implemented method for determining available transport sources according to the present invention. This method includes a phase of preparing a pairing process of the transport, i.e., receiving necessary transport data from the client interface and setting certain rules for the pairing process, corresponding to the received data, and a phase of pairing an available source with the transport or the customer requiring the transport via this customer's client interface, i.e., finding transport sources who are suitable for the specific transport, as described in the data received from the client interface, determining a paring value for the transport and transmitting this value to the suitable sources, who might then accept or decline the pairing value or choose from several offered pairing values. Pairing value might be e.g., price for transport, amount of CO2 released during the transport, score reflecting some or all of customer rating, price, CO2 amounts and time needed for arrival to the pickup location, etc.

The method might be implemented in a computer system which can communicate, e.g., via the internet, with customer devices having a client mobile app installed thereon or having any other form of a user interface such as a web application, and can communicate with source interfaces which might also be personal devices such as smartphones, tablets, watches, laptops etc., might be on-board computers, autonomous vehicles or any other potential application programming interfaces enabling the sources to communicate with the computer system running the method. Both the client interface and source interface, which might also be the same app running in different modes, serve especially as a user interface adapted to communicate with the computer system and provide it with all the data and information needed to run the present method.

The preparing phase comprises the following steps:
Step 101—Receiving a transport request, e.g., from a client interface. The transport request contains at least data about pickup location, destination location, time of pickup, and subject of the transport (e.g., number of people to be transported, size and weight of object(s) to be transported, animal transport). It might include further data such as route estimation (time and distance), if calculated by the client interface, client or passenger data (name, id, profile picture, rating by previous transport sources, classification as a frequent rider/first-time rider, etc.), business identification (e.g., if the transport would by paid by a company employing the customer instead of the customer themselves), preferred pairing mode (automatic or interactive, as will be described below), or tier. The tier data might for example group several special requirements (see below) which might often be chosen together, e.g., a premium tier might include a tip (incentive for the source), requirement for a more high-end vehicle and might exclude sources with lower customer ranking. Other tiers might e.g., represent transportation for kids or people with special needs, providing low-cost transport by combing services of transport sources with mass transport, etc.

The transport request can also contain data about special requirements, such as a preferred type of payment (cash, card, interface), presence of a taximeter, exclusion of certain transport sources (e.g., excluding based on previous bad experience, limiting sources to only a certain transport company preferable to the customer, limiting sources to freelancers only), request for an intermediate stop (which might include waiting for some time at the intermediate stop and would affect the transport time and distance and therefore also the pairing value), and so on. Further special requirements might include transportation of large luggage or animals, conversation preferences, extra wait time on pickup etc. Taximeter can be any device capable of measuring time and/or distance of a transport, e.g., a regular taximeter used in cabs, mobile application, part of an on-board computer, an IoT device capable of measuring time and/or distance etc. The requirement for a presence of a taximeter might thus broadly require presence of a certain pricing regulation, some necessary hardware, licensing and other physical or virtual limitations etc. If the customer has no special requirements the transport request can contain no data about the special requirements or data about there being no special requirements.
Step 102—Automatically generating rules for the pairing based on data from the transport request. These rules include a maximum number of iterations of the pairing process, which might be chosen in the transport request, but preferably is determined automatically based on data such as time of pickup and pickup location (which have impact on number of potentially available transport sources—the fewer such sources there are the more iterations might be needed to eventually find a suitable source), special requirements (which also impact the number of potential sources and thus source supply and thus e.g., the price (although the final price can fixed for the customer, the fixed price will it this case also be higher since finding a source to be paired will be more difficult)), estimated price for the transport etc. The rules further include a time limit for source response, i.e., how long the method will wait for sources to accept a pairing value they were offered (see step 111 below), and a point in time when the pairing will be initiated (i.e., end of the preparation phase). This point in time might be immediate, e.g., the pairing initiates as soon as possible—once the request is received and the rules are generated. The method might also postpone the initiate of the pairing process, so it is reasonably close to the time of pickup, e.g., 60 minutes or 30 minutes or 10 minutes before the time of pickup, in cases the transport request is received in advance. The point in time for initiating the pairing might depend, e.g., on number of iterations, expected number of potentially available sources (around the pickup location at the time of pickup), pairing mode etc.

The rules might further include iteration length, client response time (in interactive pairing processes), time and offer count (for initiating automatic pairing processes), groups of sources to be considered (e.g., personal transport group, delivery group, universal group, special groups for large or heavy objects, for large number of passengers etc.), pricing incentives (e.g., to increase likelihood of source acceptance in later iterations) or grouping the iterations into stages. A stage can be a number of iterations with similar or the same rules. In different stages, the rules are then different—e.g., incentives are higher in later stages, times for source/client response are longer, some special requirements might be dropped in later stages (e.g., if customer indicates in the request that they prefer a high-end vehicle or an electric vehicle, but none can be found, they would accept a lower-end vehicle/combustion engine vehicle). In later stages, the pairing might also switch from the interactive mode to the automatic mode, e.g., confirm any source accepting a pairing value automatically.
Step 103—Waiting for the generated point in time and initiating the pairing process. This step ends the preparing phase and initiates the pairing phase. Its length depends mainly on how much in advance the customer has provided the transport request and on utilization of the transport source network around the time of pickup—i.e., if there are, or are expected to be, many free (potentially available) sources at the time of pickup, the pairing might initiate later. During this step, the customer might also be able to make changes in their transport request, via their client interface, e.g., choose a different pickup location or time of pickup or add special requirements or even add another request which might be merged with the currently processed one, if such change is still possible within the remaining time.

The pairing process then for each iteration comprises the following steps:
Step 104—Pre-selecting transport sources. In this step, each potentially available source, e.g., a source with an active status selected in their source interface or with the interface/notifications from the interface (e.g., an application) turned on etc., who is currently located or will be, around the time of pickup, located near the pickup location is pre-selected. For a source having another transport preceding the one for which pairing is currently in process, the destination of this preceding transport is considered or its route is considered (e.g., to be merged with the currently processed transport route). Near the pickup location means for example within a predetermined radius from the location, i.e., actual distance to the pickup location might not considered in this step, only a straight “as-the-crow-flies” distance is measured. The radius depends on data from the transport request, e.g., it will be smaller in a city center than in countryside, it will be larger during off-peak hours, it might be larger for longer transports, etc. If there are no sources to be pre-selected, the method might wait for a certain amount of time and then try again, e.g., by initiating a new iteration. The pairing might be ended, and information about the pairing being unsuccessfully terminated is transmitted to the client interface, after several iterations (or even one iteration) without pre-selecting any sources. The radius might also become larger or smaller as the pairing goes on, e.g., in later iteration or stages if no source was found, the radius will be larger.
Step 105—Calculating special order pricing, e.g., incentives common for all pre-selected sources. The transport request might e.g., offer a tip (provided by the customer sending the request and/or by the end customer receiving a delivery, etc.), i.e., incentive increasing the likelihood of finding an appropriate source. The person/company offering access to the present method as a service, e.g., owning the server running the method, offering the interfaces, creating the source network (all sources offering their services via the source interface) etc., might also provide an incentive. This incentive might increase the likelihood of finding an appropriate source for less desirable transports, so more customers are satisfied, it might make requests from certain chosen customers more desirable, if the person/company wishes so, etc. Incentives, both from the transport request and the person/company, might be iteration-dependent, can be applied in given iteration if sources were not accepting pairing values in previous iteration(s), etc. This step might be missing in some embodiments or might come later, for example after step 106.
Step 106—Receiving availability and eligibility data and exclusion certain pre-selected transport sources based on exclusion criteria. This data are received from the source interface of each transport source and might also partially be stored in a source database, e.g., part of the server running the method, especially if they are more static (e.g., type of vehicle) then dynamic (e.g., current location). In this step, sources not suitable for the transport, as defined in the transport request, are removed from the set of pre-selected sources, so only sources who can actually provide the desired transportation service receive pairing values for this service. The exclusion criteria checked in this step for each pre-selected source are chosen from the set comprising providing a conflicting transport, participating in a pairing process for a conflicting transport, not having vehicle with a capacity sufficient for transporting the subject of the transport, and not meeting any potential special requirements.

Some or all of these criteria might be applied in a given embodiment of the invention, and further criteria might also be applied in some embodiments. Preferably, all of the above given criteria are applied. As a result, a source booked for a different, conflicting transport, is excluded in this step, as well as sources participating in a pairing process for such a conflicting transport or for several such transports (e.g., more than a predetermined threshold generated as a pairing rule). Sources having unsuitable vehicles (e.g., not willing to transport animal, having capacity not sufficient to transport given number of people or given object(s), not having electric vehicle, if the customer requested one, not having a card payment terminal, if requested, etc.) are also excluded. Sources might also be excluded if they already received a pairing value in the same stage of this pairing process, or if they received and accepted a pairing value and weren't confirmed. Some sources might have a preferred direction of travel (e.g., towards their home when an end of their working hours gets closer), and this preferred direction might be another criterion for exclusion certain sources from given pairing process.

The availability and eligibility data might thus comprise data about the source's current pairing values or planned transports, source's schedule (e.g., set working hours), vehicle data (capacity, class, taximeter . . . ), data defining a certain region within which the source can provide transports/pickup customers/unload transported goods etc., data whether the source is a company, part of a certain fleet, or a freelancer, identification of such company or fleet, rating by previous clients or customers etc. The exclusion criteria and this data provided by the transport sources preferably correspond to each other. For some criteria, a certain source might not have available data and might thus be excluded based on missing data.

The sources excluded in a certain iteration might by automatically excluded in any following iterations for the same transport, especially if they are excluded based on static criteria which are unlikely to change from iteration to iteration. Participation in other pairing processes or source's current location, on the other hand, might preferably by checked again in each iteration. Even the static criteria can change however, e.g., a source might switch vehicles, so it might be advantageous to check all the exclusion criteria in each iteration for each pre-selected source, preferably unless a given source was already offered a pairing value during this stage/pairing—inquiring a source multiple times in a single stage is preferably avoided.

Another criterion, which might be considered a part of the exclusion criteria from step 106, is an efficiency criterion. This criterion, however, is based more on the data from transport request. The efficiency criterion comprises a preset maximum distance between a source's location (current or anticipated, around the time of pickup, based on e.g., another transport the source handles at the moment) and the pickup location and/or comprises a preset maximum time of arrival to the pickup location. Preferably, both the maximum time and distance are used. For each source, it is thus determined, how far they would need to ride to the pickup location, either from their current location or the location where they'll be once they finish their current transport, once they arrive home etc. If this determined distance is more than the maximum distance, which might be generated in step 102, this source is excluded. Similarly for the maximum time of arrival, it is determined how much time the source would spend driving to the pickup location from their current or future location, and if this time exceeds the maximum time, the source is also excluded. This efficiency criterion basically prevents sources who are too far away or will be too far away from the pickup location from participating in the pairing process, thus limiting the price (which generally includes price for arriving at the pickup location) and impact on the environment (e.g., CO2 levels), which preferably form at least part of the pairing value(s).

The efficiency criterion for maximum distance might for example be generated or previously established as 3 km in a city center, 5 km in the outskirts or smaller towns (e.g., under 10 000 population), and 12 km elsewhere, based on the pickup location. Maximum time of arrival might be generated or established similarly, e.g., 10 minutes, 20 minutes, 30 minutes, in the same order. The criterion might also reflect the estimated time and distance of the requested transport, for example, it might be established in some embodiments that the maximum limits for efficiency criterion cannot be lower than the estimated time and distance of the transport. Or the maximum values can be constants, e.g., the above-given constants, multiplied e.g., by 1.5 or by 2, if the estimated distance is above e.g., 25 km. Or the maximum values can be constants, e.g., the above given constants, +a third of the estimated time or distance. The values can also e.g., be dynamic or given via machine learning or AI output. This way, the max time/distance from the efficiency criterion is less strict for longer transports, where it's reasonable to allow longer arrival times/distances.

The efficiency criterion can also depend on the number of pre-selected sources, on number of previous unsuccessful iterations etc. For example, if there are more strict special requirements, the efficiency criterion might be less strict, to increase likelihood of finding any sources. Similarly, the criterion might be less strict, if the time of pickup is during off-peak hours, e.g., at night. On the other hand, if the customer requests, e.g., as a special tier, more ecological or cheaper transport, the efficiency criterion might be stricter (e.g., smaller max distance at least for combustion engine vehicles), to push the price or carbon footprint down.

If no sources remain after this step, a new iteration might be initiated. In some embodiments, some exclusion criteria can alternatively be loosened in such a situation, and some previously excluded sources might thus continue to be considered in the method.
Step 107—Determining a pairing value/pairing values. Based on the transport request and/or the generated rules or predetermined rules in some embodiments, this step might be individual for each remaining source (e.g., they are offered the transport for different prices, because some are further away from the pickup location than others, have higher prices, more expensive or fuel consuming vehicles, different incentives etc., and the price(s) incorporated in the pairing values might reflect these differences). In some embodiments, the pairing values might also be common for all the sources, e.g., if the transport request indicates a fixed price for the transport, or if the price is determined automatically, but is the same for all the sources.

The pairing value preferably comprises a price offered to a transport source to accept or not accept. Multiple pairing values can then be offered and each source can choose a cheaper one, to increase their chances of winning the pairing process, or more expensive one, if they're only interested in the transport for the higher price. Sources having taximeters might receive pairing values according to their taximeter tariffs. Other sources might receive pairing values based on preset configurations, such as
arrival price per km
transport price per km
transport price per hour
max price
min price
min earnings per hour.

Exemplary calculation might then be:
Ride estimate: 20 km, 1 hour
Configuration: arrival 5 CZK/km, transport 15 CZK/km, 350 CZK/hr
The source is 3 km away from the pickup location.
Distance price=5*3+15*20=315 CZK
Hourly price=5*3+1*350=365 CZK
(365>315)→final pairing value=365

Alternatively, the final pairing value reflecting a price can be a sum of the distance and hourly prices (with the configuration prices lower to reflect this) or might be transport-specific. For example, in a city center, the transport would take more time per km than in a countryside, so the source might choose to ride for price-per-hour in the city center, and for price-per-km elsewhere. The final pairing value price might be further increased by an incentive or tip from the customer, by a flat fee for each ride, a commission for a vehicle owner/employer of the source, etc. If the source interface receives multiple pairing values, these values might be determined e.g., by multiplying the result of the above calculation by some coefficients, e.g., by 0.9, 1, and 1.1, by adding or subtracting a constant, etc.
Step 108—Selecting sources who will receive pairing values. This step might, in some embodiments, precede step 107, in order to avoid determining pairing values for nonselected sources. In some embodiments, all remaining sources might be selected and thus receive pairing values. In other embodiments, a maximum number of sources to be selected is generated, e.g., as a pairing rule. The remaining sources are then ranked, and the highest-ranking sources receive their pairing values and can accept one or multiple of them. Ranking might be price-based (step 107 then preferably precedes this one), customer ranking-based, based on some special requirements which were indicated as optional by the customer, distance to the pickup location based, time of arrival based (e.g., if the customer indicated they want to be picked up as soon as possible), based on estimated probability of accepting the pairing value, etc. If the number of remaining sources is lower than a threshold amount, all the sources are selected. In some embodiments, a machine learning algorithm, trained on historical data from previous pairing processes, might be used for the ranking.

The probability of accepting the pairing value (or one of the pairing values, if more of them are to be transmitted) might be based on the following criteria: The pairing value(s), arrival time and distance, current location, status of the source (free, serving a different ride, taking a break), effect of accepting/not accepting on the source's acceptance rate, previous acceptance of similar pairing values/transports, pickup and destination location (e.g., if close to the source's home or other frequent stop), length of the transport (time and/or distance), payment method, rating received via the client interface, special requirements from the transport request, expected availability of other transport requests at the time of pickup, etc. For example, a source might be more likely to accept a pairing value, if the transport destination is close to his home and his regular working hours are close to their end. Source might be more likely to accept a more expensive transport or a premium-tier transport. Some sources might prefer delivery transport to personal transports or vice versa, or might prefer transports without animals, transports not leaving a certain region etc. All these preferences might by discovered by a machine learning algorithm, i.e., they might not be explicitly generated or written down and might not be (consciously) known even to the source. The expected availability of other transport requests might be estimated by the method e.g., based on historical data from the same area at the same time, e.g., an average (mean) number of transport request occurring within this area around the time of pickup at similar days (working days, weekends, public holidays etc.).

The transport sources who were not selected in step 108, if any, are then removed from the set of pre-selected sources and the remaining sources are considered in the next step.
Step 109—Creating inquiries for the remaining sources. An inquiry comprises all the data a source needs in order to decide to accept or not accept the offered pairing value(s). More values can be accepted, e.g., each value higher than certain threshold determined or preset by the source. This data include at least the pairing value(s), and preferably also data from the transport request, such as pickup and destination locations, time of pickup, special requirements, subject of the transport, time and distance for arrival to the pickup location, client data etc. Some sources might however choose to accept pairing values solely based on their numerical value, e.g., accepting each pairing value above a threshold, e.g., offering certain amount per hour, and can thus choose not to receive other data. The source interface might thus allow the sources to select what kind of data they want to receive in the inquiries. The inquiry might also include data about the time limit for source response, e.g., in form of a countdown shown via the client interface. In case any of the remaining sources stops being available, e.g., they accept a different transport pairing value, go offline, leave the area fulfilling the efficiency criterion etc., a different source, next in line based on the ranking, might be selected for inquiry, i.e., for receiving the pairing value(s), unless all not-previously-excluded-sources were already selected.
Step 110—Transmitting inquiries to the remaining (selected) transport sources. The inquires, as defined above, are transmitted to the source interfaces and the time limit for source response initiates running.
Step 111—Waiting for the source acceptance(s) and creating, based on the acceptance(s), a set of accepting sources (i.e., of all sources who accepted at least one pairing value). This set might comprise all the sources who accepted the pairing value during the time limit, and in some embodiments might for example only comprise first N sources who accepted, where N is at least one and might be generated as a pairing rule or chosen in the transport request. The time limit for waiting was generated in step 102. In case no acceptance is received (i.e., no source accepted a pairing value in time), the pairing ends unsuccessfully (step 112C) unless there are more pairing iterations left. In that case, next iteration is initiated by step 104. These two possibilities for no received acceptance are illustrated in FIG. 1. If there is at least one received acceptance, the method continues either with step 112A or step 1128—depending either on pairing mode chosen by the client in the transport request, if the method embodiment allows the customer this choice, or depending on which of the two steps is part of the method in given embodiment. In other words, some embodiments might always comprise automatic pairing process, others might always comprise interactive pairing process, other embodiments might let the customer decide and yet other embodiments might choose step 112A or 112B based on some criterion, other choice made by the customer etc. For example, the automatic pairing might be always selected for delivery transports (i.e., subject is an object, multiple objects, animal etc.), and the interactive pairing might always occur for a personal transport (i.e., at least one person is part of the transport subject).

In an interactive pairing process, be it in embodiment not allowing other choice, embodiment where the customer choses this option, or embodiment where it was chosen automatically, step 112A follows step 111 (if some acceptance was received).
Step 112A—Transmitting relevant data about sources from the set of accepting sources to the client interface. This data might comprise arrival time estimated by the source/driver, estimated or fixed price (Depends on an embodiment, transport request, or individual sources. Estimated in case the actual price to be paid depends on the actual distance/time of the transport, fixed in case the customer is actually going to pay the price as shown in this step, regardless of actual time spent on the transport or distance traveled—in this case the cost difference between what was estimated and what was actually traveled might be borne (if negative) or earned (if positive) by the source or by the person/company providing the method to customers and sources). This data might further comprise data about the vehicle (class, eco-friendly flag if electric/hybrid vehicle, flag if autonomous vehicle, model, brand, etc.), data about the driver (photo, name, rating), if there is a driver, and so on. The pairing value(s) (e.g., prices) shown in the client interface might not be exactly equal to the pairing value(s) accepted, but might also include tax, provision for the person/company running the method etc. These sums might however also be already included in the pairing value(s), in which case the source actually makes less than what they accept.

In step 112A, the data about the set of accepting sources is delivered to the customer via the client interface, and the available transport sources are thus determined. The method might thus end at this step (or step 112C if unsuccessful). Preferably, however, it further comprises:
Step 113—Receiving source confirmation from the client interface. Time limit for waiting for the client confirmation—response time for customer or other person using the client interface, was generated in step 102. The confirmation includes data identifying the one source the customer has chosen. Further, in this step, it might be checked, whether the confirmed source is still available, e.g., is still online, does not have any conflicting transport etc. If the source is not available, the data about the set of accepting sources (without the not-anymore-available one) might be transmitted again to the client interface—repeating step 112A and then 113, next iteration might be initiated, or the pairing might end unsuccessfully if there are no more iterations. The confirmation data might also comprise identification of multiple sources (e.g., in order the customer prefers them), to avoid the situations where the confirmed source is not available to be booked anymore, and the customer must be asked to choose again/another iteration has to be initiated.

Similarly, if no confirmation is received in this step, next iteration might be initiated by returning to step 104 and increasing an iteration counter, or the pairing might end unsuccessfully, if this iteration was the last one. In some embodiments, if no confirmation is received in step 113, one of the sources might be confirmed automatically and this source and the customer are informed accordingly. Client confirmation might then be still required within a certain time limit in order to finalize the pairing and end it successfully. Preferably, the customer is only informed via the client interface about the successful pairing process, and no confirmation is needed, in order to speed up the pairing and minimize source-booking conflicts between different pairing processes.

If the confirmation was received, the confirmed source is informed accordingly via their source interface (which might also result in them being excluded from some other transport pairing process) and the successful pairing result is also transmitted to the client interface. It might be once again checked that this source is still available, similarly to the checking described above in step 113, with the same possible outcomes. These actions form Step 115—Successfully ending the pairing process, and the method thus ends.

Once the method, i.e., the pairing of the requested transport, is over, some data regarding the request and the pairing might be transmitted to the server running the method for further processing, e.g., as a part of a training set for the machine learning algorithm. Data about accepting or not accepting an offered pairing value for individual sources might also be used to update the source's acceptance rate, i.e., the proportion of offered pairing values accepted. The acceptance rate might then for example serve as a criterion (or one of multiple criteria) for ranking the sources in the selection step 108, in order to incentivize the sources to accept transports (which is advantageous because it speeds up the method). These data, transmitted to the server, might include time of completion of the pairing process, number of iterations needed, the pickup and destination locations, the pickup time, actual time and distance for the transport (sent separately after the transport is completed), the outcome of the pairing process, the final price for the transport (sent separately after the transport is completed, unless the estimated price is the actual price paid), number of pre-selected sources, number of sources remaining after exclusion(s), numbers of sources excluded by individual criteria, rules generated for the pairing etc.

In an automatic pairing process, be it in embodiment not allowing other choice, embodiment where the customer choses this option, or embodiment where it was chosen automatically, step 112B follows step 111 (if some acceptance was received). Steps 101-111 might thus be the same as described above.
Step 112B—Automatically choosing (i.e., confirming) one of the sources. In this step, the sources forming the set of accepting sources are ranked. This ranking might be independent on the ranking used in the selection of step 108, but might also be similar, use same of the same criteria or even be the same. Automatic choosing might initiate after the time for the client reaction lapsed, after a predetermined number of received acceptances, etc.

Ranking for automatic choosing is preferably based on at least one attractivity criterion from a set comprising a pairing value accepted by each accepting source in the determined pairing value, end-customer rating of each accepting source, estimated time of arrival to the pickup location, and quickness in accepting the pairing value. For example, a score is given to each source based on one or more of these criteria, and the higher the score, the better the ranking of each source. In some embodiments, the sources might thus be ranked solely on pairing values accepted, such that the source accepting the lowest pairing value is chosen and confirmed for the transport. In other embodiments, the first source to accept a pairing value might be chosen. In other embodiments, score points might be given to sources based on multiple criteria (i.e., more points for cheaper sources, more points for faster accepting sources and more points for sources closer to the pickup location etc.). The final score than determines the ranking. If multiple sources have the same score, one might be chosen randomly, or another criterion might be taken into account.

The data about the highest-ranking accepting source is then transmitted to the client interface and information about winning the pairing is transmitted to the source interface of the highest-ranking source. Further, in this step, it might be checked, whether the chosen confirmed source is still available for booking, e.g., is still online, does not have any conflicting transport, etc. If the source is not available, another might be chosen based on the ranking (if the set of accepting sources contains another source)—repeating step 112B or a part of it, next iteration might be initiated, or the pairing might end unsuccessfully if there are no more iterations/sources.

Once the pairing ends (step 115 or 112C, depending on the outcome), data regarding the request and the pairing might be transmitted to the server(s)/computer(s) running the method for further processing, as described above for the interactive pairing process.

Based on the amount of time left between receiving the transport request and the requested time of pickup, pairing processes can be divided into immediate pairing processes and pre-orders. For immediate pairing processes, the initiating point in time is as soon as the transport request is processed and rules are generated. Rules for an immediate pairing can be based on actual state of the source network, e.g., amount of traffic, number of potentially available sources (e.g., online sources, with their source interface on), number of other currently running pairing processes etc.

For preorders, i.e., pairing processes not initiating right away, the rules are generated some time before the pairing initiates, so the rules are preferably based on expected state of the source network (e.g., based on historical data) at the time of pickup. For example, it can be expected, that the number of potentially available sources will be different during regular working hours, e.g., 9 AM-5 PM, on working days than at nights or weekends. Similarly, more sources might be available for shorter transports than for out-of-town transports. Larger objects or larger amounts of goods to be transported might require special vehicles which might also limit the number of potential sources, etc.

For both immediate and pre-ordered pairing processes, the rules will thus be affected by the transport request as well as by the state of the source network. The number of iterations might for example vary between 10 and 100, but for some pairing processes, there might even be a single iteration, e.g., for when immediate pickup is request during peak hours in a city center. In some embodiments, the number of iterations might be preset, e.g., always 100 iterations or always 20. The time limit for source response, for example 20-60 seconds, might similarly depend on the above-mentioned factors, even on the number of iterations. An exclusion criterion might, in some embodiments, define, alternatively or additionally, a maximum carbon footprint for each source to arrive to the pickup location, e.g., 1000 grams of CO2, or for the whole transport. The maximum time or distance for arrival can in some embodiments also be expressed as a price for arrival, e.g., set by the customer in the transport request via the client interface, instead of number of minutes or kilometers. Cheaper sources can thus have less strict efficiency criterions.

A transport source might be an individual driver, e.g., a freelancer independent of any company or other sources, or an employee of a transport company when they are not currently needed by his employer, or a manager/coordinator of several drivers/a fleet/a company etc. Source might also be an autonomous vehicle with a source interface implemented in its control system, or a computer system managing multiple autonomous vehicles. This enables the present method to cooperate with drivers who are not actually part of the source network, i.e., they do not have the source interface. As a result, an unused transport capacity of such a company or fleet can be utilized to provide transport, and the method might provide transportation services even in areas not sufficiently (or not at all) covered by the driver network, by outsourcing transports via such a manager/coordinator, who then distributes the transports to his drivers or autonomous vehicles as they see fit.

The point in time for initiating the pairing might be determined as the last rule during the generating step 102. For example, if the limit for source response is 30 sec, limit for client response is also 30 sec and each iteration requires another 10 sec for necessary computations and data transfers etc., and it is estimated that sources will need up to 10 minutes to arrive to the pickup location (as determined by the efficiency criterion), then e.g., a 20-iteration pairing would need to initiate about 70 minutes before the requested time of pickup. The pairing might then proceed significantly faster than this estimate, since a source might be found and booked in one of the earlier iterations, in some iterations, no sources might be left to receive pairing values after exclusions, etc.

Preferably, the iterations are grouped into stages, with iterations in the same stage having the same rules. Each source interface then preferably receives a pairing value/inquiry at most once in a stage. Since the rules in the stage are still the same, it is unlikely that a given source would change his mind about accepting a pairing value or would not be excluded if they were excluded in a previous iteration. The amount of computations as well as the amount of messages/inquiries transmitted to the client or source interfaces is thus limited. The sources might also be grouped according to a company/fleet they belong to. Some rules might then be predetermined based on such a group, if the customer limits sources, e.g., to a specific company, as a special requirement, or if the person/company running the method offers the transport in earlier iterations only to certain companies etc.

Preferably, the sources who are part of the source network are grouped according to the services they are able to provide, for example into personal transport, delivery, and universal group, based on what they can transport. Each such group can further be divided based on capacity, type of vehicle, kind of accepted payment, etc. This static data might be saved in a database and many pre-selected drivers can then be excluded without the need to receive data (e.g., position or participation in other pairing processes) from their source interfaces (other than being online/potentially available so that they can be pre-selected).

In the transport request, the transport might be tagged as an emergency transport, e.g., as one of the tiers to be selected in the client interface. The rules might than be chosen accordingly, to maximally speed up the pairing and increase likelihood of finding an accepting source as soon as possible. For example, only one source could be inquired in each iteration, with automatic confirmation if they accept the pairing value (in this case, the source is preferably informed they are the only one receiving the inquiry, which increases likelihood of them accepting a pairing value, albeit a higher one), extra incentive might be offered, efficiency criterion might comprise only time of arrival as a parameter to exclude sources, etc. Similarly, a later stage might be tagged as an emergency stage with similar rules as described above.

Preferably, the pairing value is determined individually for each source and/or each source is inquired with several different pairing values to choose from. This approach pushes down the final pairing value accepted and confirmed, and thus for example makes the transportation cheaper, or more eco-friendly, depending on what parameter the pairing values reflect, since confirmation can be received for a source accepting a low-enough pairing value. At the same time, the pairing value is kept high enough for the sources to be interested in the transport or be able to fulfill its environmental criteria, since the pairing value would not be accepted otherwise.

In some embodiments, if an acceptable source is not found and confirmed within certain number of iterations, the following iterations might be sped up by transmitting each accepting source data to the client interface individually right away, i.e., without waiting for the amount of time specified as the time limit for the source response. If the client interface confirms a source, the source is booked and the pairing ends. If the pairing lasts for many iterations, it is more likely that the client interface will transmit confirmation data for any accepting source, so waiting for the time limit or for multiple accepting sources to create the set of accepting sources might be unnecessary.

The transport request might also comprise an ID of the customer, e.g., a regular customer, having special requirement common for each transport they request. For example, a specific transport company might be selected to always provide transports for given customer, the pickup location might always be the same, all transports might be delivery transports, etc. An example of such a situation might be a hotel ordering transport for its guests—the pickup location is always the same, the transport is most likely for people with luggage, destination location might most likely be an airport, etc.

For sources with a taximeter, a determined monetary pairing value might depend on a tariff configured in given taximeter based on estimated length of the transport (i.e., time and distance). The actual price paid by the might then be the price as measured by the taximeter during the transport. Otherwise, price estimate might be calculated based on each source's individual price tariff, or on a common tariff configured as a part of the method, i.e., given price per km and per hour multiplied by the estimated distance and time. The source's individual tariffs might be constrained by certain tariff rules, configured as a part of the method of the invention. E.g., upper limit on a price per km/price per h. Tariff rules might depend e.g., on special requirement, type of transport (taxi/delivery), emergency tag etc. Transport over the same route might thus have different tariff rules when the customer requests a high-end vehicle or transmits the transport request only a short time before the required pickup.

In some embodiments, a fixed price might be determined before the iterations begin and this price is then paid by the customer and shown via the client interface. The transport is then paired to a source, who might offer or accept a different price, and the difference between this accepted price and the fixed price to be paid is paid or gained by the provider of the method.

Together with receiving an accepted pairing value, the method might also receive an updated estimate of time of arrival to the pickup location. This updated estimate is transmitted by given source based on their specific knowledge, while the original estimate is calculated by the method similarly for each source, thus the updated estimate should be more precise and better informs the customer or the method. In an interactive pairing process, this updated estimate might be transmitted to the client interface instead of the previous estimate and might help the customer or client with choosing the best source. In automatic pairing process, in case the time of arrival is a criterion for choosing a source to be confirmed, this update might help with selecting the best source automatically.

In order to prevent situations where a certain source wins two conflicting pairing processes at roughly the same time, there is preferably a database of sources comprising at least data regarding all the transports each source is going to provide and is currently providing/participating in pairing process for. This database is accessible to the server/computer system etc. running the method. After a source is confirmed, the database is updated—i.e., the database contains data about the transport and about the source not being available during the estimated duration of the transport. This update is only done if the database still shows the source is available, i.e., hasn't won any conflicting pairing process. If a different pairing shows up in the database, the current pairing keeps searching for a different source. For sources who are not individual drivers, but who distribute the transports to multiple drivers, the method might wait for a confirmation by the source that they have a driver still available for given transport, and the pairing only ends once this confirmation is received.

Two transports taking place at the same time or partially overlapping times do not necessarily have to be conflicting transports/their pairing processes don't have to be conflicting pairing processes. A source might have a possibility to provide both such transports, e.g., pickup an item do be delivered while delivering a different item, if possible, i.e., unless it prevents one of the transports from being completed on time, unless it would contradict a special requirement, would limit comfort of a passenger, damage a transported object etc. A conflicting pairing process/transport which would exclude a source from a different pairing would for example be a transport initiating at a far away pickup location or requiring the source to deviate significantly from their expected route during a transport.

The client interface preferably does not receive the number of current iteration or that the pairing advances from one iteration to another, i.e., this data is not transmitted to the client interface. The client interface preferably receives only the required data about the accepting source(s) to choose from or chosen for him automatically. During the pairing process, the data about the set of accepting sources shown via the client interface might change as new sources accept pairing values (e.g., after an incentive was increased between stages), as an accepting source wins another pairing process, as not-confirmed sources are dropped etc.

The estimates for amounts of time necessary e.g., to arrive to the pickup location, carry out the transport etc., and for the lengths of routes, might be obtained by any known service providing maps (web mapping), GPS navigating, real-time traffic data, weather status etc.

The state of the source network with respect to the number of available sources for a specific transport, which is used e.g., to determine the point in time for initiating the pairing process, number of iterations etc., might be calculated as the number of all sources in the area around the pickup location, who are currently not serving any transport, divided by the number of all the online sources in this area. The area might be e.g., a radius around the pickup location or a more complex area from which the pickup location is reachable within a predetermined amount of time (e.g., 10 minutes). The ratio then basically describes local current utilization of the source network. The higher this ratio is, the easier it should be to find available sources. The number of sources might also be used, together with this ratio, when determining other parameters dependent on network utilization (number of iterations, incentives . . . ).

In a specific example, a transport request for a personal transport ride can comprise the following data.

Personal transport Request:
passenger:
passenger Id: XXX; name: John Smith; profile Image: null
rating: 4.98; frequent Rider: false; first Ride: false
requested Pickup At: null II no time was specified by the customer in the request, so the pairing initiates immediately and the sources accepting pairing values also provide an estimate of time of arrival to the pickup location
pickup:
lat: 50.0541; Ion: 14.4795
description: Čáslayská 44, 130 00 Praha, Česká Republika
destination:
lat: 50.08488; Ion: 14.43659
description: Hlavní nádraží, Wilsonova 10 Praha 2, 120 00 Praha
ride Estimate: // this might be computed e.g., by a third-party service, i.e., might not be included explicitly in data transmitted from the client interface
distance [m]: 2728
duration: 7 min, 5 sec
quality: TRAFFIC // i.e., high traffic
special Requests: null
specified Driver Id: null
excluded Personal transport Ids:
   −914210170
Business Id: null
Auto Chooser: false // the confirmation data is transmitted from the client interface
preOrder: false // this flag would be true e.g., if the request was sent a day in advance
payer Type: PERSONAL // i.e., not a business ride. This might affect price, type of payment etc.
rideParams:
accepts Credit Cards: null; premium Car: null
taximeter Required: null
consumer Price: null // would specify some predetermined pricing for certain transports or customers
commission Fee: null // would specify some predetermined pricing for certain transports or customers
payment Type: null; tier Id: null

The rules, based on this request, might then be as follows:
Pairing Rules:
preorder: false
iterations: 8
stages:
   initiate Iteration: 1
End Iteration: 2
Time limit for source response: 20 sec
Time limit for client response: 15 sec
   initiate Iteration: 3
End Iteration: 8
Time limit for source response: 20 sec
Time limit for client response: 15 sec
Continuous Broadcast: true // any accepting source automatically confirmed in this stage (e.g., for another minute), if none was found during the time limit for source response.
Auto Chooser Desired Offers: 3 // after three sources accept, one of them is chosen (by the customer via the client interface in this example, since this is an interactive personal transport pairing process)
Auto Chooser Max Wait For Desired Offers: 35 sec // or after 35 second have lapsed, a source is chosen (if any source accepted a pairing value)

Pairing values in this example can be determined e.g., as described above based on each source's per-hour rate and/or per-km rate. The radius for pre-selecting sources might be, for example, max (one third of the transport distance; 2 kilometers). The efficiency criterion can be generated, e.g., as described above.

For an exemplary delivery transport, the following data might be comprised in the transport request:
Delivery Transport Request:
pickup:
lat: 50.0610963; Ion: 14.4079028
description: Nádražní 110, 150 00 Praha 5
destination:
lat: 49.7895946; Ion: 14.4027802
description: Na Homoli 2010/44, 14300 Praha
pickup Time: 2022-07-22; 07:00:01
specified Driver Price: null // would define a predetermined pricing for certain sources/customers/types of transport
ride Estimate:
distance [m]: 10227
duration: 21 min, 28 sec
dropOffCount: 1 // number of stops where something is delivered
orderer:
name: Some Company; logo: null; business Id: 4905133004 legs:
   contact: // person providing the item to be delivered name: John Smith; phone Number: +420111222333 company: Some Company; email: smith@example.com
coordinates:
lat: 50.0610963; Ion: 14.4079028
address:
   city: Praha 5; country: Czech republic; street: Nádražní house Number: 110; zip Code: 150 00
note For Driver: Order no. 87965131, warehouse 2e
leg Id: 6a54df1a32dsf4c
package Actions:
   action Type: PICKUP
Package Id: 8as9dc416asdf3
   contact: // person receiving the item to be delivered
name: Jane Doe; phone Number: +420111222333
email: doe@example.com
lat: 49.7895946; Ion: 14.4027802
description: Na Homoli 2010/44, 14300 Praha
house Number: 14; zip Code: 110 00
leg Id: 32a1dc465a4sdf
package Actions:
   actionType: DROP_OFF
   packageId: 8as9dc416asdf3
proofOfDelivery:
mode: CODE SIGN
verification Code: 1234
   contact: // for return of the package, if not successfully delivered name: John Smith; phoneNumber: +420111222333
company: Some Company; email: smith@example.com
coordinates:
lat: 50.0610963; Ion: 14.4079028
address:
city: Praha 5; country: Czech republic; street: Nádražní
house Number: 110; zip Code: 150 00
note For Driver: Order no. 87965131
leg Id: 9ad6f31c3a4s
packages:
   customer Order Id: 654ads1ca3s
customer Stop Id: 32as3dc47
Fallback Leg Ids: // if not delivered, return to fallback leg
   9ad6f31c3a4s // ID of the fallback leg
Package Id: 8as9dc416asdf3
Collect On Delivery: null
Product Settings Id: some-company-express // specifies a type of product common for a customer, e.g., same day delivery
Order Type: LOGISTICS

The rules might then be as follows:
Pairing Rules:
iterations: 182
stages:
   initiate Iteration: 1
End Iteration: 6
Time limit for source response: 20 sec
emergency: false
skippable: false // true if rest of the stage's iterations should be skipped if there are no sources matching the criteria—can be used to not waste time by waiting for specific sources or if all available sources were already inquired and the pairing should move to the next stage and inquire them again, e.g., with larger incentive
driver Rules:
   car Class: EFFICIENCY
Driver Group: CARGO
initiate Iteration: 7
End Iteration: 34
Time limit for source response: 20 sec
emergency: false; skippable: false
driver Rules:
   driver Group: UNIVERSAL
   driver Group: CARGO
initiate Iteration: 35
End Iteration: 58
Time limit for source response: 20 sec
emergency: false; skippable: false
driver Rules:
   car Class: EFFICIENCY
Driver Group: TAXI; Incentive Multiplier: ‘1.05’
   car Class: STANDARD II personal transport sources with standard cars have different incentives than with efficiency cars and than universal drivers
Driver Group: TAXI; Incentive Multiplier: ‘1.1’
   driver Group: CARGO
   driver Group: UNIVERSAL; Incentive Multiplier: ‘1.05’
initiate Iteration: 59
End Iteration: 112
Time limit for source response: 20 sec
emergency: false; skippable: false
driver Rules:
   car Class: EFFICIENCY
Driver Group: TAXI; Incentive Multiplier: ‘1.15’
   driver Group: CARGO; Incentive Multiplier: ‘1.08’
   driver Group: UNIVERSAL; Incentive Multiplier: ‘1.15’
   car Class: STANDARD
Driver Group: TAXI; Incentive Multiplier: ‘1.2’
initiate Iteration: 113
End Iteration: 182
Time limit for source response: 25 sec
emergency: true; skippable: false
driver Rules:
   driver Group: CARGO; Incentive Multiplier: ‘1.2’
   car Class: STANDARD
Driver Group: TAXI; Incentive Multiplier: ‘1.5’
   car Class: EFFICIENCY
Driver Group: TAXI; Incentive Multiplier: ‘1.4’
   car Class: PREMIUM
Driver Group: TAXI; Incentive Multiplier: ‘1.65’
   driver Group: UNIVERSAL; Incentive Multiplier: ‘1.4’
response Time Grace Period: 5 sec
identity: Default Prague // preset rules for Prague
default: false // default rules for delivery, not used
bonus Amounts: [ ]//incentives independent of stages/iterations, e.g., predetermined for certain customers, none in this case

Pairing values in this example can be determined e.g., as described above based on each source's per-hour rate and/or per-km rate. The radius for pre-selecting sources might be, for example, maximum of one half of the transport distance and 3 kilometers. The efficiency criterion can be generated, e.g., as described above.

A subject of the present invention is also a computer system comprising means for carrying out the steps of the method of the invention, e.g., in any embodiment described above. This system might operate as a cloud service, might be a server owned by the person/company providing the method or multiple such servers etc. The communication with the client and source interface is preferably an online communication. The interfaces might be only user interfaces for receiving data from customer and sources and transmitting them to the system and for showing data from the system to the customers or sources (e.g., drivers). In some embodiments, however, certain calculations might also be done by the interface, by a third-party web services etc.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A computer-implemented method comprising:
receiving a transport request containing data that includes at least data about: a pickup location, a destination location, a time of pickup, a subject of the transport, and potential special requirements including a type of payment, exclusions of some transport sources, and a request for an intermediate stop;
generating rules for a pairing process based on the data contained in the transport request, wherein the rules include at least a maximum number of iterations of the pairing process, a time limit for source response, and a point in time for initiating the pairing process; and
initiating the pairing process at the point in time;
wherein for each iteration, the pairing process comprises:
pre-selecting transport sources situated within a radius from the pickup location based on source location data received via a source interface;
receiving, from the source interface of each pre-selected source, availability and eligibility data, and excluding, based on these data, pre-selected transport sources based on at least one exclusion criterion selected from a set comprising at least: providing a conflicting transport, participating in a pairing process for a conflicting transport, not having vehicle with a capacity sufficient for transporting the subject of the transport, and not meeting any potential special requirements;
Generating an efficiency criterion for the transport and excluding transport sources not fulfilling the efficiency criterion, wherein the efficiency criterion comprises at least one parameter selected from a maximum distance between the source's current location or destination and the pickup location, and a maximum time of arrival to the pickup location;
Determining at least one pairing value for each remaining transport source based on the transport request, and transmitting the at least one pairing value to each remaining transport source's source interface; and
Receiving pairing acceptance data from the source interfaces during the time limit for source response;
wherein for each iteration, the pairing process further comprises one of the following steps:
If pairing acceptance data was not received from any transport source in this iteration and the maximum number of iterations was already reached, terminating the pairing process, and transmitting, to a client interface, information about the pairing process being terminated;
If pairing acceptance data was not received from any transport source in this iteration and the maximum number of iterations was not yet reached, initiating next iteration; and
If pairing acceptance data was received from at least one accepting transport source, creating a set of available transport sources, and transmitting, to the client interface, data about at least one transport source from the set of available transport sources.

2. The method according to claim 1 wherein the creating of the set of available transport sources comprises ranking the accepting transport sources based on at least one source attractivity criterion selected from a set comprising a pairing value accepted by each accepting source, customer rating of each accepting source, estimated time of arrival to the pickup location, and quickness in accepting the pairing value, wherein data about the highest ranking accepting source are transmitted to the client interface, pairing winning information is transmitted to the source interface of the highest ranking source, and the pairing is ended.

3. The method according to claim 1 wherein the transmitting of data about at least one transport source comprises transmitting data about each transport source from the set of available transport sources, wherein the method further comprises a step of receiving a source confirmation data from the client interface, wherein for each iteration, the pairing process further comprises one of the following steps:
If source confirmation data were not received in this iteration within a predetermined time period and the maximum number of iterations was already reached, terminating the pairing and transmitting, to the client interface, information about the pairing being unsuccessful;
If source confirmation data was not received in this iteration within the predetermined time period and the maximum number of iterations was not yet reached, initiating next iteration; and
If source confirmation data was received, transmitting pairing winning information to the source interface of the confirmed source, and ending the pairing process.

4. The method according to claim 3 wherein the data about each transport source comprise at least some of the following data:
Estimated time of arrival to the pickup location
Pairing value for the transport accepted by the transport source
The transport source's vehicle data
Customer rating of the transport source.

5. The method according to claim 1 wherein in the step of determining the at least one pairing value, the determination is individual for each transport source.

6. The method according to claim 1 wherein for at least some transport sources, multiple pairing values are determined, wherein the pairing value acceptance data from these at least some transport sources further comprises pairing value selection data.

7. The method according to claim 1 wherein before the step of determining the at least one pairing value, further pre-selected transport sources are excluded based on source-specific data including at least one of: source pricing, source customer rating, estimated time of arrival to the pickup location, source's preferred direction of travel, source's rate of accepting received pairing values in previous pairing processes, and estimated probability of accepting a pairing value in the current pairing process.

8. The method according to claim 7 wherein the exclusion is at least partially based on the estimated probability of accepting a pairing value in the current pairing process, wherein the estimated probability is determined based on at least some of the following data:
The source's distance to the pickup location
Time needed for arrival to the pickup location
The source's current location
Transport distance
Estimated time needed for completing the transport
Impact of potentially not accepting a pairing value in the current pairing process on the source's rate of accepting received pairing values
The source's rating
Rating of customer by previous transport sources
Potential special requirements in the transport request
Expected availability of other transport requests at the time of pickup.

9. The method according to claim 1 wherein the special requirement for exclusion of some transport sources includes at least one of excluding transport sources of at least one predetermined fleet or transport company and limiting transport sources to transport sources of at least one predetermined fleet or transport company.

10. The method according to claim 1 wherein the determining of the pairing value includes adding a source incentive value, generated among the rules for the pairing, to the pairing value for at least some transport sources.

11. The method according to claim 1 wherein the point in time for initiating the pairing is generated based on an estimated number of pre-selectable transport sources within the given radius from the pickup location at the time of pickup.

12. The method according to claim 1 wherein transmitting the pairing value to each remaining transport source further includes transmitting, to the source interface of each remaining transport source, transport data comprising at least some of the following data:
Client data and subject of the transport data
Pickup and destination locations
Time of pickup
Potential special requirements
The time limit for source response
Distance to the pickup location
Estimated time for arriving to the pickup location.

13. A computer system comprising means adapted for carrying out each of the steps of the method according to claim 1.
